(19) United States
(12) Patent Application Publication
(10) Pub. No.: US 2024/0383282 A1
(43) Pub. Date: Nov. 21, 2024

(54) WHEELS WITH ANTI-BUILD-UP PROPERTIES, TRACK SYSTEMS AND VEHICLES WITH SAME

(71) Applicant: SOUCY INTERNATIONAL INC., Drummondville (CA)

(72) Inventor: Jeremie AUBIN-MARCHAND, St-Hugues (CA)

(21) Appl. No.: 18/667,562

(22) Filed: May 17, 2024

Related U.S. Application Data
(60) Provisional application No. 63/467,029, filed on May 17, 2023.

(51) Int. Cl. B60C 11/04; B60C 11/03

(52) U.S. Cl. CPC B60C 11/045; B60C 2011/0341; B60C 2011/0358

(57) ABSTRACT

Wheels, wheel assemblies, track systems, and vehicles are disclosed. The wheel has a hub portion and a tread portion disposed about the hub portion. The tread portion has a first plurality of grooves extending laterally from a first sidewall of the tread portion towards a second sidewall of the tread portion. The first plurality of grooves are circumferentially spaced along the tread portion. A radial depth of a first groove from the first plurality of grooves is greater proximate to the first sidewall than proximate to the second sidewall. The first groove has an ellipsoidal shape.

### CROSS-REFERENCE

The present application claims priority to U.S. Provisional Application No. 63/467,029, filed on May 17, 2023, the entirety of which is incorporated herein by reference in its entirety.

### FIELD OF TECHNOLOGY

The present technology generally relates to wheels with anti-build-up properties, to track systems and vehicle with same.

### BACKGROUND

During movement of tracked vehicles over snow, powdered snow particularly, snow builds up around wheels of a track system to an extent where it can become detrimental to the performance of the track system. The build-up phenomenon may also be observed with spherical sand and/or fine sand and/or any other debris (e.g., mud, dirt, etc.).

In one example, snow can get compressed between a wheel and an endless track of the track system. This results in an overall slowing down of the vehicle (i.e., loss of speed of the vehicle) and/or an increase of the rolling resistance and/or a premature wear of the track system and/or premature wear of one or more components of the track system. Additionally, if the vehicle is powerful enough, build-up may cause breaking of the tensioner or wheel shafts of the track system.

U.S. Pat. No. 3,875,986, incorporated herein by reference, discloses tread structures for evacuating snow. The tread structures disclosed in this document comprise transverse zigzag grooves and longitudinal linear grooves that operate by filling up the tread grooves. Such tread structures are however not optimal for evacuation of other types of debris such as for example, powder snow or fine sand.

U.S. Pat. No. 9,207,150, incorporated herein by reference, discloses staggered tread structures for evacuation of mud. The tread structures disclosed in this document are not optimal for evacuation of other types of debris such as snow and fine sand and in particular powder snow.

There is thus a need for wheels for track systems that facilitate the evacuation of debris, thus preventing their accumulation or build-up that may potentially deteriorate performance of the track system.

### SUMMARY

It is an object of the present technology to ameliorate at least some of the inconveniences present in the prior art. In some embodiments of the present technology, there is provided a wheel with a tread portion that helps in preventing build-up of debris in the track system.

Conventional tread portions are designed to make use of centrifugal forces for expelling debris. Developers have realized that effectiveness in preventing build-up and/or expelling debris of such solutions depends on the rotational speed of a given wheel. In some embodiments of the present technology, there is provided a wheel with a tread portion that helps in preventing build-up and/or expelling debris at different rotational speeds of the given wheel. In these embodiments, the given wheel may help in preventing build-up and/or expelling debris at relatively low rotational speeds.

Conventional tread portions are often designed to be used with one direction of rotation of the wheel for expelling debris, such as when the vehicle is moving forward, debris is expelled backward, for example. Developers have realized that such solutions are ill-suited for expelling debris when the wheel is rotating in the other direction, such as when the vehicle is moving backward, for example. In some embodiments of the present technology, there is provided a wheel with a tread portion that helps preventing build-up and/or expelling debris during different rotational directions of the given wheel. In these embodiments, the given wheel may help in preventing build-up and/or expelling debris when the wheel is rotating in a forward direction and when rotating in a backward direction.

Developers have realized that narrow wheels accumulate comparatively less debris due to a comparatively smaller surface area in contact with the endless track. However, due to the comparatively higher pressure applied to the endless track, using narrower wheels may be detrimental to the endless track, especially when large loads are to be supported. Developers have also realized that wide wheels accumulate comparatively more debris due to a comparatively larger surface area in contact with the endless track. However, due to comparatively lower pressure applied to the endless track, using wider wheels may be better suited to distribute loads on the endless track and/or to reduce vibration in the endless track. In some embodiments of the present technology, there is provided a wheel with a tread portion that combines one or more advantages of using narrow and wide wheels. In these embodiments, the wheel is well-suited to distribute the load on the endless track and which has a small contact surface with the endless track for preventing build-up and/or expelling debris.

The track system may comprise one or more idler wheels to guide the endless track and maintain tension of the endless track, via a tensioner, for example. Developers of the present technology have realized that built-up debris between the idler wheel and the endless track may affect the tension of the endless track. In some embodiments of the present technology, there is provided an idler wheel with a tread portion that helps in preventing built-up and/or expelling debris, and help in maintaining the tension of the endless track.

According to one aspect of the present technology, there is provided a wheel for a track system. The wheel comprises a hub and a tire portion. The tire portion comprises a tread portion. The tread portion is made of a resilient material. The tread portion comprises a first plurality of grooves extending laterally from a first sidewall of the tread portion towards a second sidewall of the tread portion, the first plurality of grooves being circumferentially spaced, and a radial depth of the first plurality of grooves is greater proximate to the first sidewall than proximate to the second sidewall.

In some embodiments of the wheel, the tread portion also comprises a second plurality of grooves extending laterally from the second sidewall towards the first sidewall, the second plurality of grooves being circumferentially spaced, and a radial depth of the second plurality of grooves is greater proximate the second sidewall than proximate to the first sidewall. The grooves of the second plurality of grooves have a length smaller than a length of grooves of the first plurality of grooves.

In some embodiments of the wheel, the tread portion also comprises a third plurality of grooves extending laterally from the second sidewall towards the first sidewall, the third plurality of grooves being circumferentially spaced, and a radial depth of the third plurality of grooves is greater proximate the second sidewall than proximate to the first sidewall. The third plurality of grooves is laterally aligned with the first plurality of grooves.

In some embodiments of the wheel, a given groove from at least one of the first plurality of grooves, the second plurality of grooves and the third plurality of grooves, has an ellipsoidal shape.

In some embodiments of the wheel, a given groove from at least one of the first plurality of grooves, the second plurality of grooves and the third plurality of grooves, is defined by at least one sloped surface with an elliptical profile. A slope with an elliptical profile may have progressively changing bending randii and/or progressively changing normal orientations of respective stations along the slope.

In some embodiments of the wheel, a tread portion has a tread pattern with first pressure zones and second pressure zones. The first pressure zones are configured to apply comparatively higher pressure to an endless track than the second pressure zones. The first pressure zones are configured to separate debris accumulated between the wheel and the endless track. The second pressure zones are configured to expel debris accumulated between the wheel and the endless track. Pressure applied along the length of a given first pressure zone may progressively change. Pressure applied along the length of a given second pressure zone may progressively change.

In some embodiments of the wheel, the wheel is a support wheel configured to support the load of the track system. In other embodiments of the wheel, the wheel is an idler wheel configured to guide and maintain tension of the endless track. In further embodiments of the wheel may be an idler-support wheel configured to support the load of the track system, and guide and maintain tension of the endless track.

In one broad aspect of the present technology, there is provided a wheel for a track system, comprising a hub portion and a tread portion disposed about the hub portion. The tread portion comprises a first plurality of grooves extending laterally from a first sidewall of the tread portion towards a second sidewall of the tread portion, the first plurality of grooves being circumferentially spaced along the tread portion, a radial depth of a first groove from the first plurality of grooves being greater proximate to the first sidewall than proximate to the second sidewall. The first groove has an ellipsoidal shape.

In some embodiments of the wheel, the first groove has a groove surface, a slope of the groove surface having an elliptical profile.

In some embodiments of the wheel, the groove surface is at least one of a bottom surface and a sidewall of the first groove.

In some embodiments of the wheel, the first groove has a transversal axis that is parallel to an axis of rotation of the wheel.

In some embodiments of the wheel, the first groove has an axial curvature for expelling debris from the first groove.

In some embodiments of the wheel, the first groove comprises a flexible ridge for expelling debris out of the first groove.

In some embodiments of the wheel, the first plurality of grooves is formed from joining the hub portion and the tread portion together.

In some embodiments of the wheel, the tread portion further comprises a second plurality of grooves extending laterally from the second sidewall towards the first sidewall, the second plurality of grooves being circumferentially spaced along the tread portion, a radial depth of a second groove from the second plurality of grooves being greater proximate to the second sidewall than proximate the first sidewall, the second groove having a length smaller than a length of the first groove.

In some embodiments of the wheel, the second groove is disposed circumferentially between two adjacent grooves of the first plurality of grooves.

In some embodiments of the wheel, the second groove has an ellipsoidal shape.

In some embodiments of the wheel, the wheel is an idler wheel of the track system.

In some embodiments of the wheel, the wheel is a support wheel of the track system.

In some embodiments of the wheel, the wheel is an idler-support wheel of the track system.

In some embodiments of the wheel, the tread portion is made of resilient material.

In some embodiments of the wheel, the resilient material is an elastomer.

In some embodiments of the wheel, the wheel further comprises a third plurality of grooves extending laterally from the second sidewall towards the first sidewall, the third plurality of grooves being circumferentially spaced along the tread portion, a radial depth of a third groove from the third plurality of grooves being greater proximate to the second sidewall than proximate to the first sidewall, the third groove being laterally aligned with a corresponding groove of the first plurality of grooves.

In some embodiments of the wheel, the third groove has an ellipsoidal shape.

In an other broad aspect of the present technology, there is provided a track system for a vehicle. The track system comprises a frame, a drive wheel assembly rotationally connected to the frame and operatively connectable to the vehicle, a wheel assembly rotationally connected to the frame, and an endless track surrounding the drive wheel assembly and the wheel assembly, the endless track being drivingly engaged with the drive wheel assembly. The wheel assembly comprises a wheel, the wheel comprises a hub and a tread portion disposed about the hub portion. The tread portion comprises a first plurality of grooves extending laterally from a first sidewall of the tread portion towards a second sidewall of the tread portion, the first plurality of grooves being circumferentially spaced along the tread portion, a radial depth of a first groove from the first plurality of grooves being greater proximate to the first sidewall than proximate to the second sidewall, the first groove having an ellipsoidal shape.

In some embodiments of the track system, the wheel assembly is an idler wheel assembly.

In some embodiments of the track system, the wheel assembly is a support wheel assembly.

In the context of the following description, “outwardly” or “outward” means away from a longitudinal center plane of the track system, and “inwardly” or “inward” means toward the longitudinal center plane. In addition, in the context of the following description, “longitudinally” means in a direction parallel to the longitudinal center plane of the track system in a plane parallel to flat level ground, “laterally” means in a direction perpendicular to the longitudinal center plane in a plane parallel to flat level ground, and “generally vertically” means in a direction contained in the longitudinal center plane along a height direction of the track system generally perpendicular to flat level ground. Note that in the Figures, a “+” symbol is used to indicate an axis of rotation. In the context of the present technology, the term “axis” may be used to indicate an axis of rotation.

In the present description, the “leading” components are components located towards the front of the vehicle defined consistently with the vehicle's forward direction of travel, and the “trailing” components are components located towards the rear of the vehicle defined consistently with the vehicle's forward direction of travel. In the following description and accompanying Figures, the track system is configured to be attached to a right side of the chassis of the vehicle. In the context of the present technology, the qualification of a wheel assembly as “at least indirectly connected” includes a wheel assembly that is directly connected to the at least one wheel-bearing frame member as well as a wheel assembly that is connected to the wheel-bearing frame member through an intermediate structure or structures, be they intermediate frame members or otherwise.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of a vehicle having track systems, according to some embodiments of the present technology;

FIG. 2 is a perspective view taken from a bottom, front, left side of one track system of FIG. 1, according to some embodiments of the present technology;

FIG. 3 is a perspective view taken from a top, back, left side of a portion of the track system of FIG. 2 with a frame of the track system being omitted;

FIG. 4 is a top view of the portion of the track system of FIG. 3;

FIG. 5A is a partial section view taken from a top, front and left side of a left wheel of the track system of FIG. 2, according to first embodiment of the present technology;

FIG. 5B is the partial section view of the left wheel of FIG. 5A viewed from a top, front and right side;

FIG. 6A is another depicted of the partial section view of the left wheel of FIG. 5A with a hub portion of the left wheel being omitted;

FIG. 6B is another depicted of the partial section view of the left wheel of FIG. 5B, with the hub portion being omitted;

FIG. 6C is a close-up view of one side of the left wheel of FIG. 5A;

FIG. 6D is a close-up view of the other side of the left wheel FIG. 5A;

FIG. 7 is a perspective view taken from a top, front, right side of a resilient portion of the wheel of FIGS. 5A and 5B, and having a tread portion with first, second and third grooves formed therein, according to some embodiments of the present technology;

FIG. 8A is a cross sectional view taken through line A-A of FIG. 7 showing a cross section of one of the first grooves of the resilient portion of FIG. 7;

FIG. 8B is a cross sectional view taken through line B-B of FIG. 7 showing a cross section of one of the second grooves of the resilient portion of FIG. 7;

FIG. 9 is a close-up plan view of the tread portion of FIG. 7 showing one of the first and third grooves of the resilient portion of FIG. 7;

FIG. 10 is a close-up plan view of the tread portion of FIG. 7 showing some of the second grooves of the resilient portion of FIG. 7;

FIG. 11 is a perspective view taken from a top, front, right side of a second embodiment of a resilient portion of a left wheel of a track system;

FIG. 12A is a perspective view taken from a top, front and left side of a third embodiment of a wheel of the track system of FIG. 2, the wheel comprising a hub portion and a resilient portion;

FIG. 12B is another depiction of the perspective view of the wheel of FIG. 12A with an endless track of the track system of FIG. 2 being dotted out;

FIG. 13 is a plan view of one side of the wheel of FIG. 12A;

FIG. 14 is a cross sectional view taken through line C-C of FIG. 12A;

FIG. 15 is a perspective view of a resilient portion of the wheel of FIG. 12A;

FIG. 16 is a perspective view of a hub portion of the wheel of FIG. 12A; and

FIG. 17 is a partial perspective view of the hub portion of the wheel of FIG. 12A;

FIG. 18 is a simplified representation of a configuration of a track system comprising an idler-support wheel assembly;

FIG. 19 depicts an ellipse with an elliptical profile;

FIG. 20A depicts a simplified representation of an elliptical profile of a sloped surface of a groove having an ellipsoid shape; and

FIG. 20B depicts a simplified representation of debris evacuation from the groove of FIG. 20A.

### DETAILED DESCRIPTION

### Off-Road Vehicle

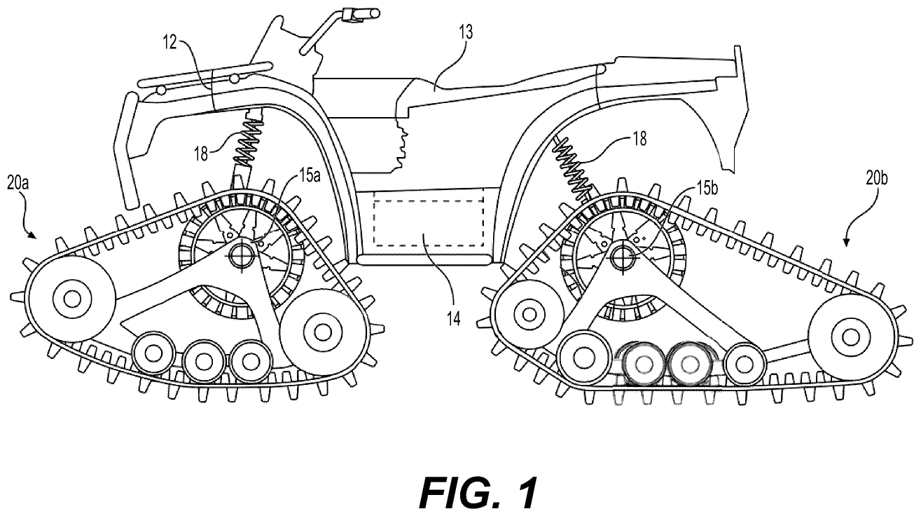

Referring to FIG. 1, the present technology will be described with reference to a vehicle 10. The vehicle 10 is an off-road vehicle 10. More precisely, the vehicle 10 is an all-terrain vehicle (ATV) 10. It is contemplated that in other embodiments, the vehicle 10 could be another type of recreational vehicle such as a snowmobile, a side-by-side (S×S) vehicle or a utility-task vehicle (UTV).

A person skilled in the art will understand that it is also contemplated that some aspects of the present technology in whole or in part could be applied to other types of vehicles that may include, but are not limited to, agricultural vehicles, industrial vehicles, military vehicles or exploratory vehicles.

The vehicle 10 has two front track systems 20a (only the left one is shown in the accompanying FIGS.) in accordance with embodiments of the present technology, and two rear track systems 20b (only the left one is shown in the accompanying Figures) also in accordance with embodiments of the present technology. In some embodiments, the vehicle 10 could have more or less than four track systems.

The vehicle 10 includes a frame 12, a straddle seat 13 disposed on the frame 12, a powertrain 14 (shown schematically), a steering system 16, a suspension system 18, and the track systems 20a, 20b.

The powertrain 14, which is supported by the frame 12, is configured to generate power and transmit said power to the track systems 20a, 20b via driving axles, thereby driving the vehicle 10. More precisely, the front track systems 20a are operatively connected to a front axle 15a of the vehicle 10 and, the rear track systems 20b are operatively connected to a rear axle 15b of the vehicle 10. It is contemplated that in some embodiments, the powertrain 14 could be configured to provide its motive power to both the front and the rear axles 15a, 15b, to only the front axle 15a or to only the rear axle 15b (i.e., in some embodiments, the front axle and/or rear axle could be a driving axle). In some embodiments, the track systems 20a, 20b are operatively connected to non-driven axle of unpowered vehicles (e.g., a trailer).

It is contemplated that the configuration and location of the powertrain 14 on the vehicle 10 may vary depending on inter alia various implementations of the present technology. In some embodiments, the vehicle may be an electric vehicle, and the corresponding powertrain may comprise an electric motor configured to propel the vehicle, and a battery configured to supply power to the electric motor. In other embodiments, a powertrain of the vehicle may have a six-wheel drivetrain (6×6) configuration with three axles with track systems on each axle capable of being driven simultaneously. In further embodiments, a powertrain of the vehicle may have an eight-wheel drivetrain (8×8) configuration with four axles with track systems on each axle capable of being driven simultaneously. Unlike a four-wheel (4×4) drivetrain configuration of the powertrain 14, the 6×6 and 8×8 configurations are often used for heavy-duty off-road and military purposes, such as heavy-duty tractors, and armored vehicles, for example.

The steering system 16 is configured to enable an operator of the vehicle 10 to steer the vehicle 10. To this end, the steering system 16 includes a handlebar 17 that is operable by the operator to direct the vehicle 10 along a desired course. In other embodiments, the handlebar 17 could be replaced by another steering device such as, for instance, a steering wheel. The steering system 16 is configured so that in response to the operator handling the handlebar 17, an orientation of the front track systems 20a relative to the frame 12 is changed, thereby enabling the vehicle 10 to turn in a desired direction.

It is contemplated that the configuration of the steering system 16 may vary depending on inter alia various implementations of the present technology. In some embodiments, the vehicle 10 may be embodied as an autonomous vehicle with a corresponding steering system controllable via one or more actuators. For example, a controller may transmit one or more signals to the actuators of the steering system for autonomously steer the corresponding vehicle without (and/or with limited) human intervention.

The suspension system 18, which is connected between the frame 12 and the track systems 20a, 20b allows relative motion between the frame 12 and the track systems 20a, 20b, and can enhance handling of the vehicle 10 by absorbing shocks and assisting in maintaining adequate traction between the track systems 20a, 20b and the ground.

The track systems 20a, 20b are configured to compensate for and/or otherwise adapt to the suspension system 18 of the vehicle 10. For instance, the track systems 20a, 20b are configured to compensate for and/or otherwise adapt to alignment settings, namely camber (i.e., a camber angle, “roll”), caster (i.e., a caster angle, “steering angle” and/or toe (i.e., a toe angle, “yaw”), which are implemented by the suspension system 18. As the vehicle 10 could have been originally designed to use wheels instead of the track systems, the alignment settings could originally have been set to optimize travel, handling, ride quality, etc. of the vehicle 10 with the use of wheels. Since the track systems 20a, 20b are structurally different and behave differently from wheels, the track systems 20a, 20b may be configured to compensate for and/or otherwise adapt to the alignment settings to enhance their traction and/or other aspects of their performances and/or use.

### Track System

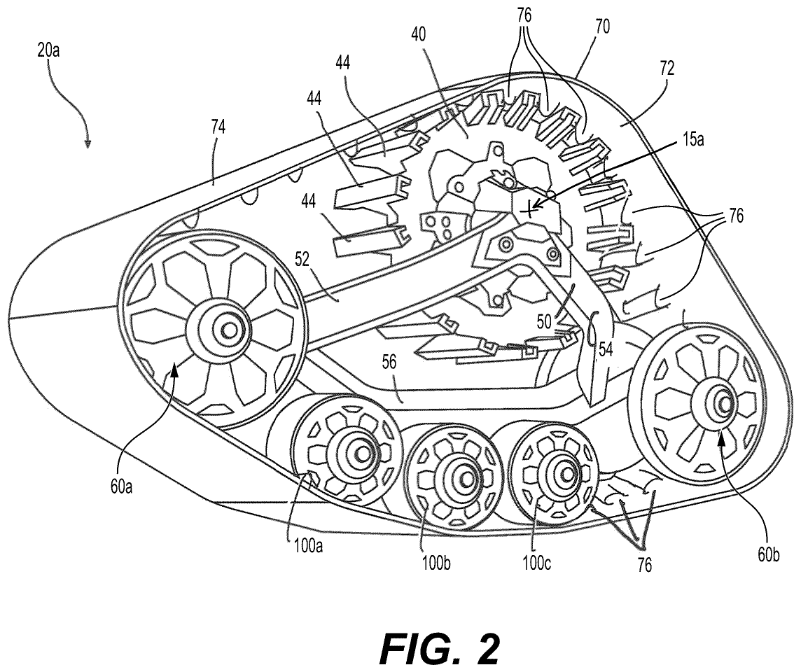

Referring now to FIG. 2, the track systems 20a, 20b will be described in greater detail. Being that the front and rear track systems 20a, 20b are similar, only the front left track system 20a will be described herewith.

The track system 20a includes a drive wheel assembly 40 which is operatively connectable to the driving axle 15a. The driving axle 15a can drive the drive wheel assembly 40 to drive the track system 20a. The drive wheel assembly 40 defines laterally extending engaging members 44 (i.e., teeth) disposed on the circumference of the drive wheel assembly 40. The engaging members 44 are adapted, as will be described in greater detail below, to engage with lugs 76 provided on an inner surface 72 of an endless track 70 of the track system 20a. It is contemplated that in other embodiments, the configuration of the drive wheel assembly 40 and thus the manner in which the drive wheel assembly 40 engages the endless track 70 could differ without departing from the scope of the present technology.

The track system 20a further includes a frame 50. The frame 50 includes a leading frame member 52, a trailing frame member 54 and a lower frame member 56. The leading and trailing frame members 52, 54 are jointly connected around the driving axle 15a, the joint connection being positioned laterally outwardly from the drive wheel assembly 40. The leading frame member 52 extends forwardly and downwardly from the joint connection and connects to a forward portion of the lower frame member 56. The trailing frame member 54 extends rearwardly and downwardly from the joint connection and connects to a rearward portion of the lower frame member 56. The lower frame member 56, which is positioned below the joint connection, extends generally parallel to the forward direction of travel of the vehicle. In the present embodiment, the leading, trailing and lower frame members 52, 54, 56 are integral. It is contemplated that in other embodiments, the leading, trailing and lower frame members 52, 54, 56 could be distinct members connected to one another. It is contemplated that in other embodiments, the configuration of the frame 50 could differ without departing from the scope of the present technology. For instance, it is further contemplated that in some embodiments, the frame 50 could include more or less than three members. In some embodiments, one or more of the leading, trailing and lower frame members 52, 54, 56 could be pivotally connected to one another.

### Idler Wheel Assemblies and Support Wheel Assemblies

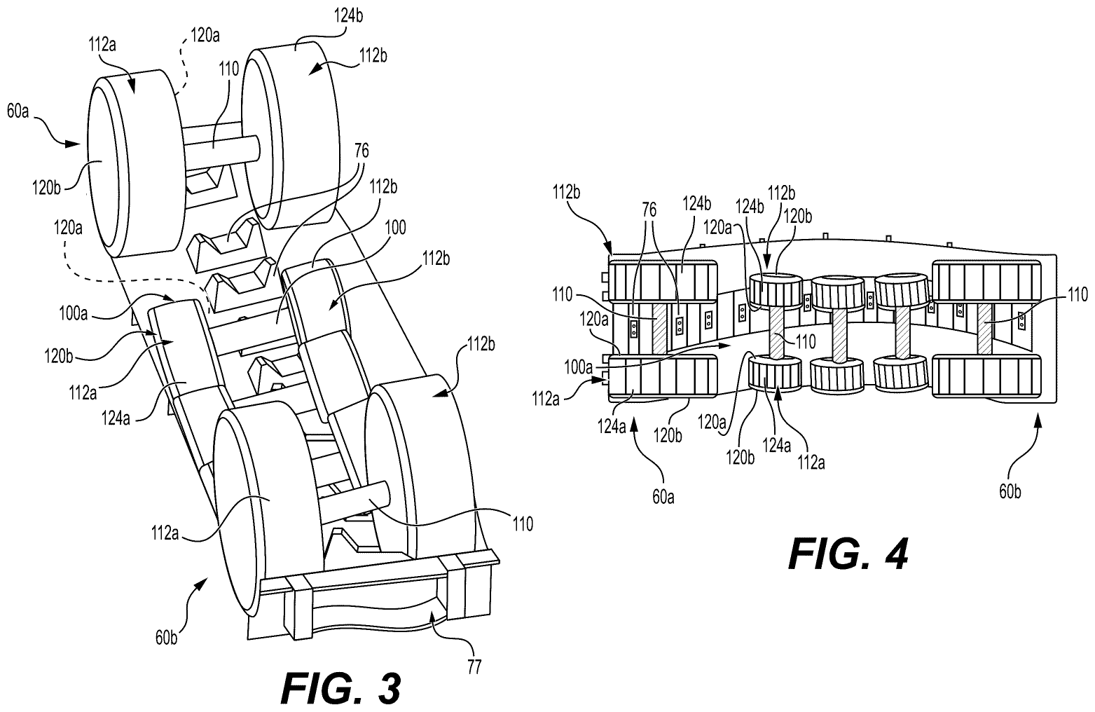

With continued reference to FIG. 2, the track system 20a further includes a leading idler wheel assembly 60a, a trailing idler wheel assembly 60b, and a plurality of support wheel assemblies 100a, 100b, 100c. In this embodiment, the track system 20a includes three support wheel assemblies, but it is contemplated that the track system 20a could include more or less than three support wheel assemblies. As best seen in FIGS. 3 and 4, each of the leading and trailing idler wheel assemblies 60a, 60b and the support structures 100a, 100b, 100c include two laterally spaced wheels 112a, 112b. It is contemplated that in some embodiments, at least one of the leading and trailing idler wheel assemblies 60a, 60b, and the support wheel assemblies 100a, 100b, 100c could have a single wheel, or three or more laterally spaced wheels.

It is contemplated that configurations of the leading and trailing idler wheel assemblies 60a, 60b and/or of the support wheel assemblies 100a, 100b, 100c may vary depending on inter alia various implementations of the present technology. In some embodiments, at least one idler wheel assembly and/or at least one support wheel assembly of the track system 20a may comprise a first wheel, and a second wheel that is laterally and/or longitudinally spaced from the first wheel.

In other embodiments, at least one idler wheel assembly and/or at least one support wheel assembly of the track system 20a may be a tandem wheel assembly that is symmetrical relative to a longitudinal center plane of the track system 20a. In further embodiments, at least one of the support wheel assemblies of the track system 20a may be a tandem wheel assembly that is asymmetrical relative to a longitudinal center plane of the track system 20a.

The leading idler wheel assembly 60a is rotationally connected to a leading end of the lower frame member 56, the trailing idler wheel assembly 60b is rotationally connected to a trailing end of the lower frame member 56, and the support wheel assemblies 100a, 100b, 100c, which will be described in greater detail below, are connected to the lower frame member 56 longitudinally between the leading and trailing idler wheel assemblies 60a, 60b.

In some embodiments, at least one of the leading and trailing idler wheel assemblies 60a, 60b could be connected to the lower frame member 56 via a tensioner (not shown), where the tensioner is operable to adjust the tension in the endless track 70 by selectively moving the at least one of the leading and trailing idler wheel assemblies 60a, 60b toward or away from the frame 50. It is contemplated that tension in the endless track 70 may be provided and/or adjusted via other tensioning means, such as shims, for example, and without departing from the scope of the present technology.

The track system 20a also includes the endless track 70, which extends around components of the track system 20a, notably the frame 50, the leading and trailing idler wheel assemblies 60a, 60b and the support wheel assemblies 100a, 100b, 100c. The endless track 70 has the inner surface 72 and an outer surface 74. The inner surface 72 of endless track 70 has lugs 76 (shown in FIGS. 2, 3 and 4). The lugs 76 are adapted to engage with the engaging members 44 of the drive wheel assembly 40. As mentioned previously, other engagement configurations between the drive wheel assembly 40 and the endless track 70 are contemplated as well. The outer surface 74 of the endless track 70 has a track tread 77 defined thereon. It is contemplated that the track tread 77 could vary from one embodiment to another. In some embodiments, the track tread 77 could depend on the type of vehicle 10 on which the track system 20a is to be used and/or the type of ground surface on which the vehicle 10 is destined to travel. In the present embodiment, the endless track 70 is an elastomeric endless track. Specifically, the endless track 70 is a polymeric endless track.

With reference to FIGS. 3 and 4, the support wheel assemblies 100a, 100b, 100c and the idler wheel assemblies 60a, 60b will now be described in greater detail. In one embodiment, the support wheel assemblies 100a, 100b, 100c, and the idler wheel assemblies 60a, 60b are pivotally connected to the frame 50, but could be rotationally connected to the frame 50 in other embodiments. The support wheel assemblies 100a, 100b, 100c are similar, and thus, only the support wheel assembly 100a will be described in greater detail. The idler wheel assemblies 60a, 60b are similar, and thus, only the idler wheel assembly 60a will be described in greater detail.

The support wheel assembly 100a includes a shaft 110 connecting the left wheel 112a and the right wheel 112b. The shaft 110 is connected to the lower frame member 56 (not visible in FIGS. 3 and 4). In some embodiments, the shaft 110 is rotationally connected to the lower frame member 56 via a bearing. The left wheel 112a is disposed on a left side of the lugs 76, and the right wheel 112b is disposed on a right side of the lugs 76. Being that the lugs 76 are generally disposed at a center of the track system 20a, the left and right wheels 112a, 112b can be considered to be, respectively, on a left side and a right side of a longitudinal center plane of the track system 20a. The shaft 110 extends in the lateral direction such that the left and right wheels 112a, 112b are laterally spaced from lugs 76 by more than is at least some conventional in track systems.

The idler wheel assembly 60a includes a shaft 110 connecting the left wheel 112a and the right wheel 112b. The shaft 110 is connected to the lower frame member 56 (not visible in FIGS. 3 and 4). In some embodiments, the shaft 110 is rotationally connected to the lower frame member 56 via a bearing. The left wheel 112a is disposed on a left side of the lugs 76, and the right wheel 112b is disposed on a right side of the lugs 76. Being that the lugs 76 are generally disposed at a center of the track system 20a, the left and right wheels 112a, 112b can be considered to be, respectively, on a left side and a right side of a longitudinal center plane of the track system 20a. The shaft 110 extends in the lateral direction such that the left and right wheels 112a, 112b are laterally spaced from lugs 76 by more than is at least some conventional in track systems.

In some embodiments of the present technology, one or more idler wheel assemblies and/or one or more support wheel assemblies may be “tandem” assemblies. The function of a tandem assembly, in general, is to allow a pair of longitudinally spaced wheels to collaboratively pivot about a transversal axis. This provides, inter alia, better conformance to the ground (ride quality, traction, etc.) and to absorb at least a portion of the vibration induced by the obstacles the track systems travel.

In at least one embodiment, the tandem assembly may be “symmetrical” relative to a longitudinal plane of the tandem assembly. A symmetrical tandem assembly is said to be symmetrical in that a longitudinal distance between axles on a first side of the longitudinal center plane is generally equal to a distance between axles on the other side of the longitudinal center plane.

In at least one other embodiment, the tandem assembly may be “asymmetrical” relative to a longitudinal plane of the tandem assembly. An asymmetrical tandem assembly is said to be asymmetrical in that a longitudinal distance between axles on a first side of the longitudinal center plane is generally greater to a distance between axles on the other side of the longitudinal center plane.

In some embodiments, a given track system may be provided without support wheel assemblies all together. For example, the given track system may be configured for use with a snowmobile. In this example, the given track system may comprise one or more idler wheels as contemplated herein, as well as one or more slides instead of support wheel assemblies.

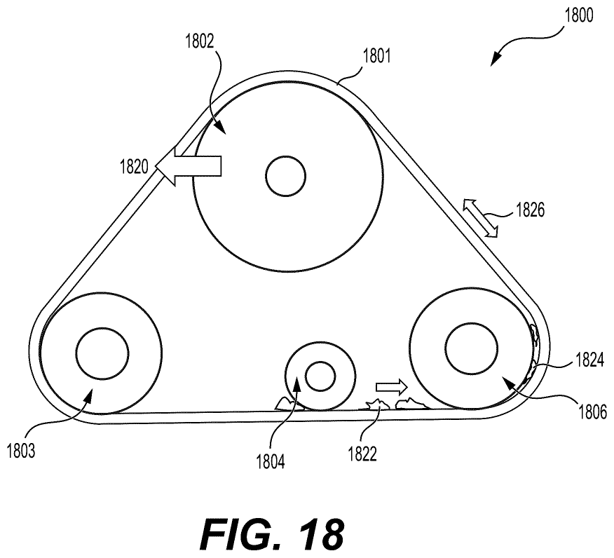

With reference to FIG. 18, there is depicted a simplified representation of a track system 1800 with an idler-support wheel configuration. The track system 1800 comprises an endless track 1801, a drive wheel 1802, a leading idler-support wheel assembly 1803, a support wheel assembly 1804, and a trailing idler-support wheel assembly 1806. It is contemplated that the track system 1800 may have additional components similar to the track system 20a, but which are omitted from simplified representation in FIG. 18 for the sake of simplicity.

It is contemplated that in this idler-support wheel configuration, the track system 1800 comprises a pair of idler-support wheel assemblies that are used as both idler wheel assemblies and support wheel assemblies. In other words, the leading and trailing idler-support wheel assemblies 1803 and 1806 are configured to guide the endless track 1801, maintain the tensions of the endless track 1801 (via one or more tensioners, for example), and to support the load on the track system 1800.

In this idler-support wheel configuration, the leading and trailing idler-support wheel assemblies 1803 and 1806 are more likely to accumulate debris because the corresponding wheels are closer to the ground surface than idler wheel assemblies that do not support the load and receive debris mainly by the “conveyor effect” of an endless track.

As seen in FIG. 18, uncompressed debris 1822 may be introduced onto the endless track 1801, and when the track system 1800 is moving in a direction 1820, the uncompressed debris 1822 may be introduced between the trailing idler-support wheel assembly 1806 and the endless track 1801. Compressed debris 1824 may accumulate between the trailing idler-support wheel assembly 1806 and the endless track 1801 and increase a tension 1826 in the endless track 1801. Developers have realized that providing idler wheel assemblies with anti-buildup properties may be beneficial for maintaining tension in a given track system.

Other configurations of idler wheel assemblies and support wheel assemblies are contemplated as well. Also, it is understood that other parts and hardware may be present in the idler wheel assemblies and the support wheel assemblies, as known in the art.

### Wheels—General

With reference to FIGS. 3 and 4, the wheels 112a, 112b will now be described in greater detail. Although the wheels 112a, 112b are described with reference to the support wheel assembly 100a, it is contemplated that one or more of the support wheel assemblies 100b, 100c and the front and rear idler wheel assemblies 60a, 60b may include the wheels 112a, 112b. In other words, the wheels 112a, 112b could be part of the support wheel assemblies and/or the idler wheel assemblies, without departing from the scope of the present technology.

The wheels 112a, 112b are sometimes referred to as resilient wheels. One advantage of the wheels of the present technology is to provide a wheel that is narrower than conventional wheels due to the material of which it is formed. Another advantage of the wheels of the present technology is their improved or optimized tread structures that contribute to preventing snow build-up and to preventing an increase of tension within the endless track so as to maintain lower rolling resistance in snow and in particular in powder snow. In some cases, the tread structures of the wheels 112a, 112b can contribute to distribute load or pressure to the inner surface 72 of the endless track 70 in a way that maximizes the durability of the endless track 70. Furthermore, resilience of the wheels 112a, 112b can further assist in absorbing at least a portion of shocks and impacts, which can improve ride-quality of the track systems in some cases.

The wheel 112a has an inner side 120a that is oriented towards the lugs 76, and an outer side 120b that is oriented away from the lugs 76. Likewise, the wheel 112b has an inner side 120a that is oriented towards the lugs 76, and an outer side 120b that is oriented away from the lugs 76. In other words, inner sides 120a of the wheels 112a, 112b are closer to the longitudinal center plane of the track system 20a than their corresponding outer sides 120b. The wheel 112a has, extending laterally between the inner and outer sides 120a, 120b, a peripheral surface 124a. Similarly, the wheel 112b has, extending laterally between the inner and outer sides 120a, 120b, a peripheral surface 124b.

As the wheels 112a, 112b are similar, only the wheel 112a will be described in detail herein.

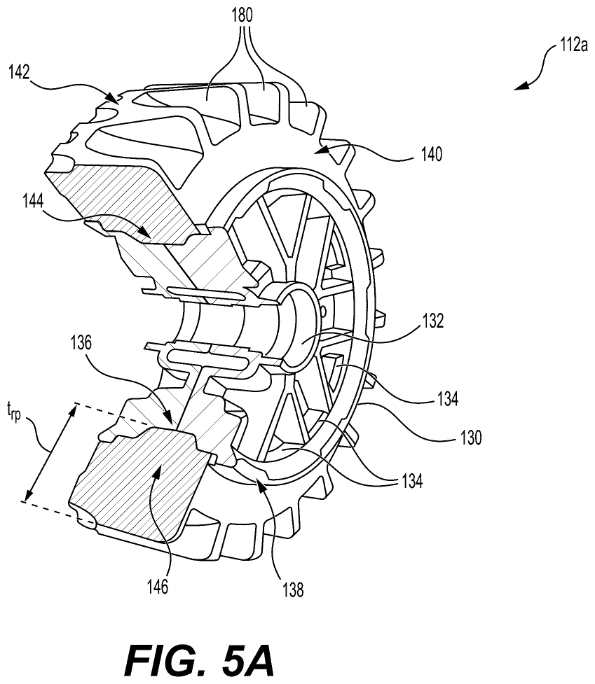

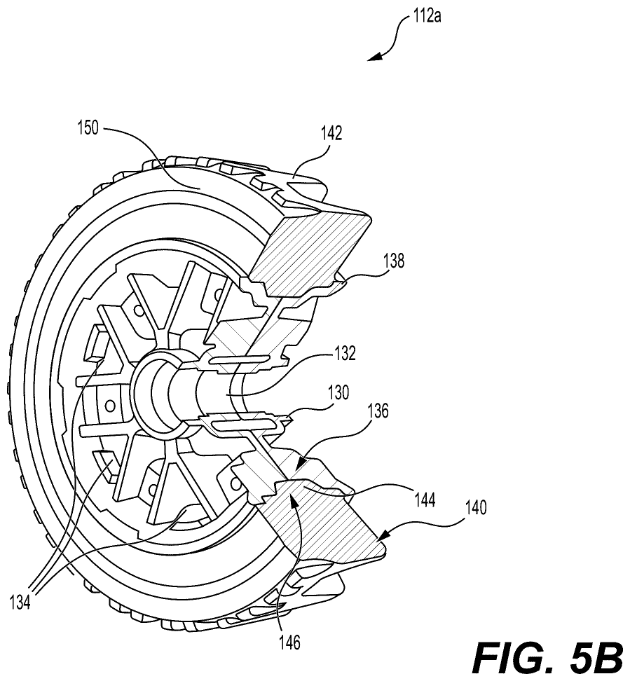

Now referring to FIGS. 5A and 5B, the wheel 112a has a hub portion 130 and a resilient portion 140 which is also referred to herein as a “tire portion” or a “tire”.

The hub and resilient portions 130, 140 are two separate portions that are connectable to one another. It is contemplated that the hub and resilient portions 130, 140 can be connected to one another in a variety of ways, such as, but not limited to, by mechanical interlocking, chemical bonding and/or by overmolding. It is to be noted that the connection between the hub and resilient portions 130, 140 is configured to provide a sealed junction therebetween.

In one embodiment, the hub portion 130 is made of a rigid material. In some instances, the hub portion 130 is made of an Ultra-High Molecular Weight (UHMW) material with a low coefficient of friction which exhibits high abrasion and wear resistance, such as, but not limited to, UHMW polyethylene (UHMW-PE). The hub portion 130 defines a central aperture 132 that is configured to receive at least part of the shaft 110 therein. In some embodiments, the central aperture 132 could be configured to receive one or more bearings therein. The hub portion 130 also defines a plurality of apertures 134. The plurality of apertures 134 can assist in reducing the amount of material required to manufacture the hub portion, which, in turn, can reduce weight as well as manufacturing costs thereof. On a peripheral surface thereof, the hub portion 130 has a connecting feature 136. More specifically, in this embodiment, the connecting feature 136 is a recess. In other embodiments, the connecting feature 136 could be a protrusion. As will be described below, the connecting feature 136 is configured to connect to a complimentary connecting feature 146 of the resilient portion 140. In some embodiments, the hub portion 130 could have one or more lips 138 thereon for providing a sealed junction between the hub portion 130 and the resilient portion 140.

The resilient portion 140 is sized and configured to be disposed around the hub portion 130. In some embodiments, the resilient portion 140 could be sized and configured to have an interference fit with the hub portion 130. Thus, in some embodiments, the wheel 112a is assembled by stretching the resilient portion 140 (e.g., stretching on a cone) over the hub portion 130. As mentioned earlier, the resilient portion 140 has the connecting feature 146, which is complementary to the connecting feature 136. The connecting features 136, 146 can provide a mechanical interlock between the hub and resilient portions 130, 140, which can assist in enhancing connection therebetween. The hub portion 130 is a single-piece. In other embodiments (not shown), the hub portion comprises two or more sub-portions joined together. The sub-portions may comprise lateral sub-portions, each with the lip 138 that extends over the resilient portion 140 and which together sandwich the resilient portion 140 when assembled together.

The resilient portion 140 is made of a resiliently deformable material, such as a polymer and/or an elastomer. In some embodiments, the resilient portion 140 is made of rubber.

In some instances, the resilient portion 140 is made of a resiliently deformable material that has a durometer hardness of between 70 and 90 duro Shore A. In certain embodiments, the resiliently deformable material of the resilient portion 140 may be selected so as to have a hardness that minimizes sticking of the snow and ice onto the resilient portion, i.e., being soft enough to deform and thus prevent snow and/or ice build-up thereto.

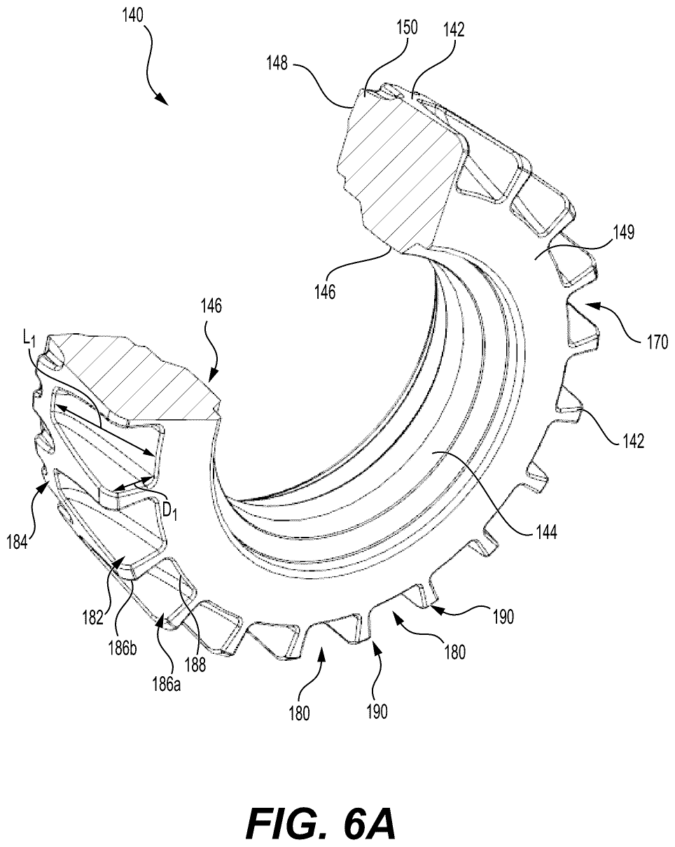

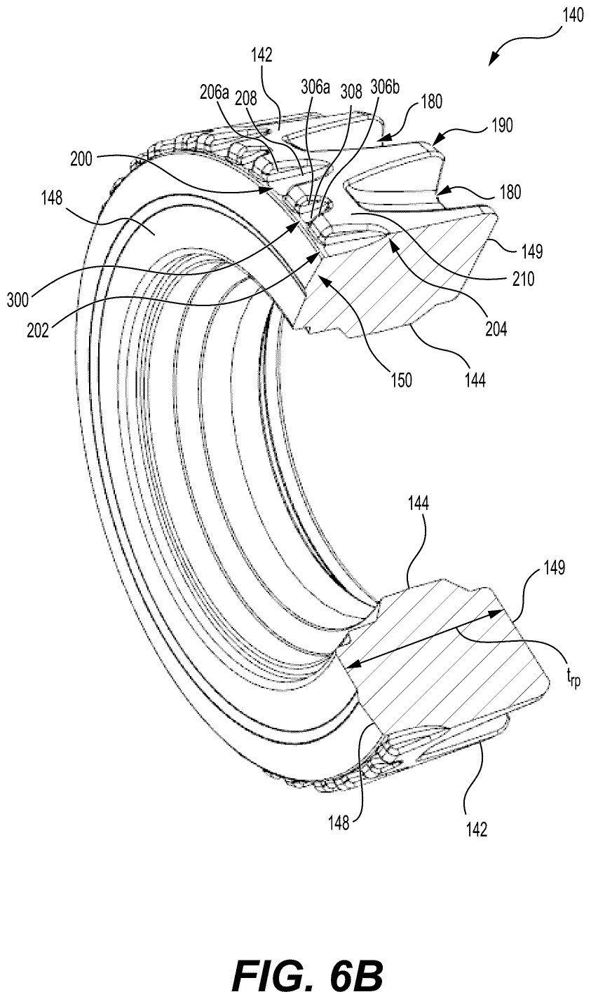

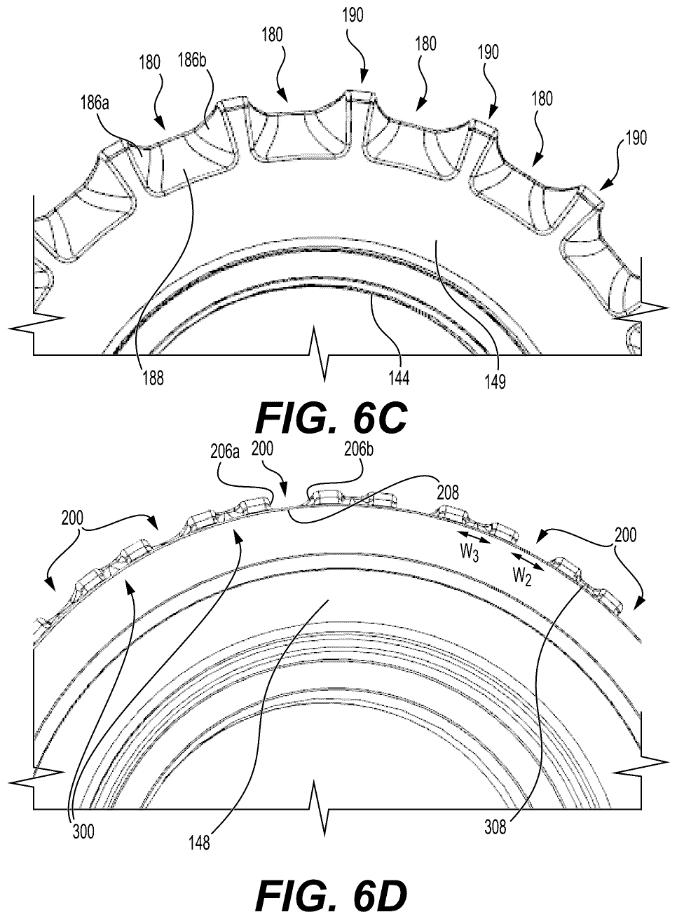

As seen in FIGS. 5A, 5B, 6A, 6B in some embodiments, the resilient portion 140 is solid (e.g., does not comprise an air chamber or foam insert). In other embodiments (not shown), the resilient portion 140 has an air chamber (e.g., a pneumatic tire).

The resilient portion 140 comprises an outer surface 142 and an inner surface 144. The inner surface 144 interfaces with the hub portion 130. The connecting feature 146 is positioned on the inner surface 144. The resilient portion 140 has a tread portion 170 on at least a portion of the outer surface 142, as well as side walls 148, 149 extending therefrom. In use, the tread portion 170 engages the inner surface 72 of the endless track 70. The sidewall 148 is part of the inner side 120a of the wheel 112a. The sidewall 149 is part of the outer side 120b of the wheel 112a.

The resilient portion 140 may have any suitable diameter. A thickness of the resilient portion 140 (denoted as “trp” on FIGS. 5B and 6B), ranges from between about 2 cm and about 4 cm. In another example, the thickness of the resilient portion is about 2.5 cm.

As best seen in FIGS. 5B and 6B, a wear-reducing element 150 is provided on the sidewall 148 of the resilient member 140. The wear-reducing element 150 is configured to reduce wear between the resilient portion 140 and the lugs 76. The wear-reducing element 150 is connected to the resilient portion 140 at the side of the wheel 112a facing the lugs 76. For example, when the lugs 76 are centered on the inner surface 72 of the endless track 70 with the wheels 112a, 112b being disposed facing each outward side of the lugs 76, the wear-reducing element 150 is connected at the inner side 120a of the resilient portion 140 of each wheel 112a, 112b. In another example, when the lugs 76 are disposed on the inner surface 72 of the endless track 70 and facing an outward side 120a of the wheel 112a, the wear-reducing element 150 is connected at the outer side 120b of the resilient portion 140 of the wheel 112a. During operation of the track system 20a, the endless track 70 can move while overcoming obstacles. In some instances, in response to one lateral side of the endless track 70 moving by a given amount, the inner side 120a of one of the wheels 112a, 112b can engage the lugs 76. This engagement can cause the one of the wheels 112a, 112b and the endless track 70 to wear out. According to an aspect of the present technology, the wear-reducing element 150 is configured to engage the lugs 76 and to therefore wear through contact with the lugs 76.

The wear-reducing element 150 at least partially extends outwardly further than an adjacent portion of the sidewall 148 of the resilient portion 140 in order to come into contact with the lugs 76 before the resilient portion 140. As illustrated, the wear-reducing element 150 is a continuous band that is integrated into the resilient portion 140, such as by molding or overmolding.

In other embodiments, the wear-reducing element 150 is separate from and connected to the resilient portion 140 by any one or more of overmolding, bonding, mechanical interlocking, for example. In some instances, the wear-reducing element 150 is removably connected to the resilient portion 140. In other instances, the wear-reducing element 150 is permanently connected to the resilient portion 140.

The wear-reducing element 150 is made of a wear-resistant material with a low coefficient of friction such as, for example: polymers such as UHMW-PE and urethane, ceramics. It is contemplated that in some embodiments, the wear-reducing element 150 can be formed as a coating on the resilient portion 140, such as from hard cast urethane.

The wear-reducing element 150 is configured to have any configuration, shape and size for the intended function. For example, the wear-reducing element 150 may comprise a single piece or be segmented with a gap between adjacent segments in some cases. A surface of the wear-reducing element 150 may be continuous or discontinuous.

A lateral thickness of the wear-reducing element 150 can vary from between about 1 mm and about 5 mm. A radial thickness of the wear-reducing element 150 can vary from between about 1 mm and about 5 mm. It is contemplated that the lateral and radial thicknesses of the wear-reducing element 150 could vary to some extent, so long as the wear-reducing element 150 can deform with the resilient portion 140. As such, the continuous band does not impede deformation of the wheel 112a. The wear-reducing element 150 may have various shapes without departing from the present technologies such as described in U.S. Provisional Application No. 63/408,776 and U.S. Provisional Application No. 63/420,276, both incorporated herein by reference in their entirety.

It is contemplated that during manufacturing of the wheel 112a, the wear-reducing element 150 can be added to the resilient portion 140 after connecting the resilient portion 140 to the hub portion 130. In some embodiments, the wheel 112a is assembled by connecting the resilient portion 140 to the hub portion 130, and then adding the wear-reducing element 150 to the resilient portion 140. In other embodiments, the wheel 112a is assembled by connecting the wear-reducing element 150 to the resilient portion 140, and then connecting the resilient portion 140 and the wear-reducing element 150 to the hub aperture 130. In yet other embodiments, the wear-reducing element 150 to the resilient portion 140 and integrally made. It is contemplated that the wear-reducing element 150 can be omitted in some embodiments.

### Tread Portion

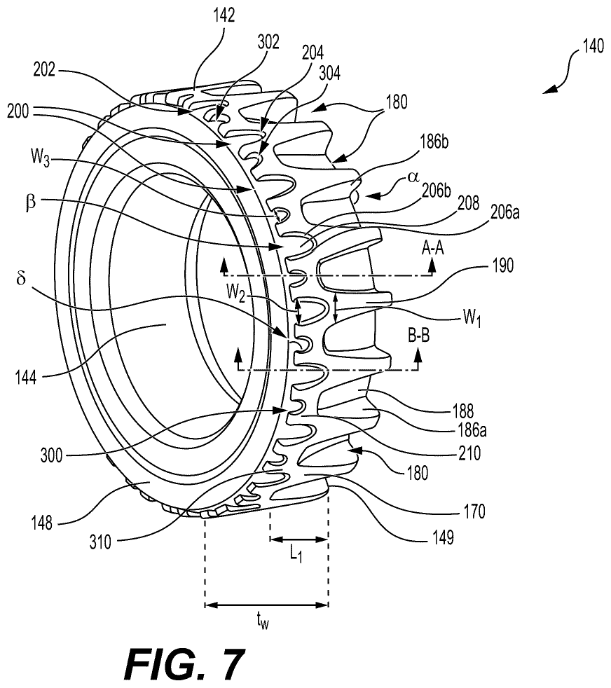

Turning now to the tread portion 170 defined on a portion of the outer surface 142 of the resilient portion 140. As best seen in FIG. 7, the tread portion 170 has a tread width (t_{w}) which generally spans from the sidewall 148 to the sidewall 149.

The tread portion 170 generally comprises sets of repeating grooves, selected from one or more of: a first set of grooves, a second set of grooves and a third set of grooves.

As it will be described in greater details herein further below, a tread portion of 170 of the wheel 112a may have a tread pattern with first pressure zones and second pressure zones. It should be noted that grooves from the first set of grooves, the second set of grooves and/or the third set of grooves define the second pressure zones which apply comparatively less pressure on the endless track 70 than the first pressure zones of the tread pattern.

### First Set of Grooves

The first set of grooves comprises a plurality of grooves 180 formed in the resilient portion 140, each of the grooves 180 extending laterally from the sidewall 149 towards the sidewall 148 without extending completely across the entire tread width (t_{w}). In other words, each groove 180 of the first set of grooves 180 stops short of the sidewall 148. The grooves 180 of the first set of grooves are spaced radially from one another, with a spacing between adjacent grooves 180 being a regular spacing. In other embodiments, the first plurality of grooves 180 may be irregularly spaced from one another.

As best seen in FIGS. 6A, 7 and 9, each groove 180 is defined by groove inclined walls 186a, 186b extending from a groove bottom 188. Together, groove inclined walls 186a, 186b and groove bottom 188 form a substantially ellipsoidal shape of the groove 180. An open end 182 of the groove 180 is open at the sidewall 149 and a closed end 184 of the groove 180 is not open to the sidewall 148.

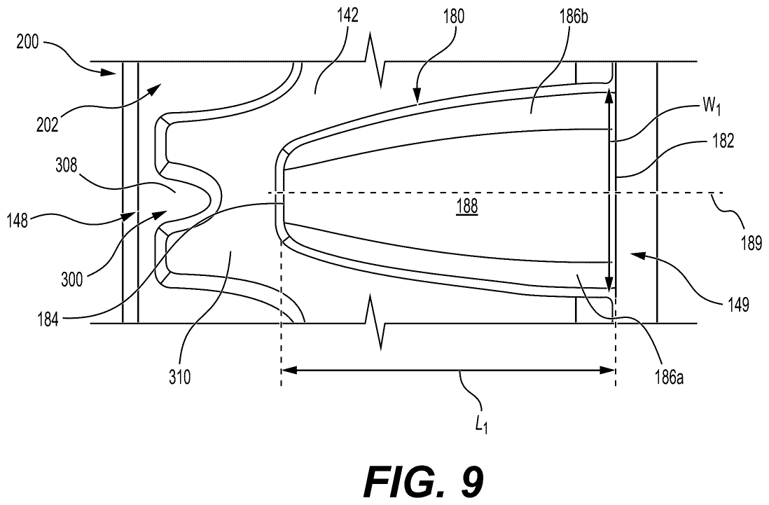

Each groove 180 has a length (l₁), a width (w₁) and a depth (d₁). The depth is a radial distance from the outer surface 142 to the groove bottom 188. The width (w₁) is a distance between the groove inclined walls 186a, 186b when viewed from the outer surface 142 (FIG. 9). The length (l₁) is a distance between the open and closed ends 182, 184 when viewed from the outer surface 142 (FIG. 9). All the grooves 180 of the first set of grooves have substantially the same length, depth and width configuration as each other. In other embodiments, at least some of the grooves 180 of the first set of grooves may have different size and shape configurations from each other.

In some embodiments, a maximum length (l₁) of each groove 180 is between about 50% to about 85%; or between 60% and 80%, or between about 66% and about 75% of the tread width (t_{w}).

As best seen in FIG. 9, the width (w₁) of each groove 180 decreases from the sidewall 149 towards the sidewall 148. Each groove 180 can be said to exhibit a progressive width profile. The maximum width is at the sidewall 149. In some embodiments, the width (w₁) is between about 5 mm and about 20 mm, or between 5 mm and 15 mm, or between 5 mm and 10 mm.

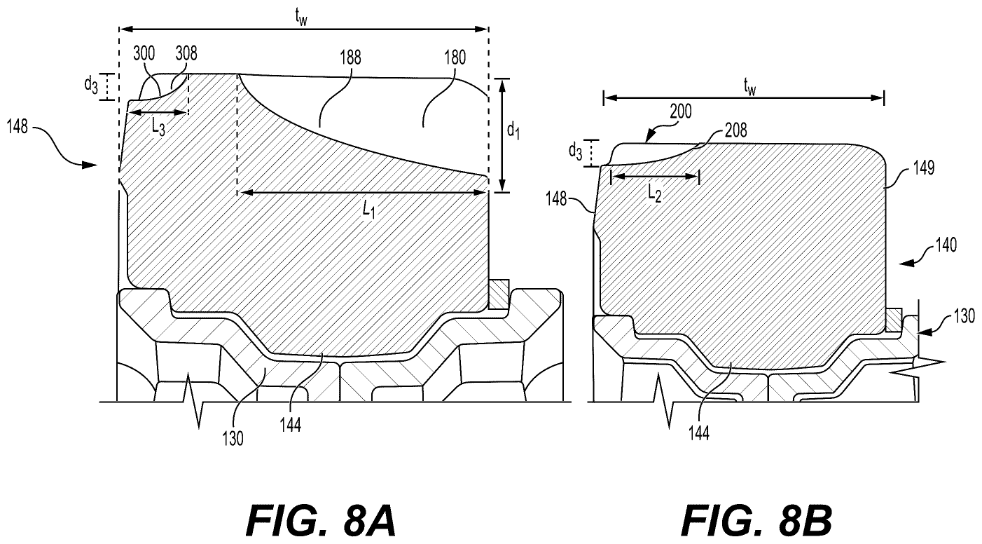

As best seen in FIGS. 6A and 8A, each groove 180 exhibits a progressive depth profile in which the depth (d₁) decreases from the sidewall 149 towards the sidewall 148 of the resilient portion 140. The depth is greater proximate the sidewall 149 than at the sidewall 148. The depth (d₁) at the open end 182 is greater than the depth (d₁) at the closed end 184. The maximum depth (d₁) of the groove 180 ranges between 5.0 mm and 10.0 mm, more preferably between 6.0 mm and 9.0 mm. In certain embodiments, each groove 180 has a maximum depth (d₁) of 7.5 mm. In some instances, the slope of each grooves 180 facilitates removal of the snow.

As seen in FIG. 6C, a side-elevation profile of the groove 180 when viewed from the sidewall 149, is substantially U shaped. It will be appreciated that the profile of the groove 180 when viewed from the sidewall 149 becomes progressively smaller towards the sidewall 148.

The cross-section of the resilient portion 140 of FIG. 8A shows that a slope of the groove bottom 188 has an elliptical profile. It is contemplated that the slope of the groove bottom 188 may have a profile that is substantially similar to the profiles of slopes of the groove inclined walls 186a, 186b (FIG. 9).

Lateral ridges 190 separate adjacent grooves 180 of the first set of grooves. The lateral ridges 190 have a width (wl₁) that increases from the sidewall 149 towards the sidewall 148.

The grooves 180 comprise a transversal axis 189 that is parallel to an axis of rotation of the resilient portion 140.

The grooves 180 of the first set of grooves allow snow to be funneled towards the open end 184 of the groove (which is at an outer side 120b of the wheel 112a) and contribute to evacuating the snow out of the groove 180. The groove 180 configuration may also prevent the snow from accumulating (building-up) on the tread portion 170. Ultimately, it is understood that the snow is then thus evacuated from the track system.

### Second Set of Grooves

Turning now to the second set of grooves 200 defined in the tread portion 170. The second set of grooves 200 comprises a plurality of grooves 200 formed in the resilient portion 140, each of the grooves 200 extending laterally from the sidewall 148 towards the sidewall 149 without extending completely across the entire tread width (t_{w}). In other words, each groove 200 of the second set of grooves 200 stops short of the sidewall 149. The grooves 200 of the second set of grooves are spaced radially from one another, with a spacing between adjacent grooves 200 being a regular spacing. In other embodiments, the second plurality of grooves 200 may be irregularly spaced from one another.

As best seen in FIGS. 6B, 6D, 7 and 10, each groove 200 is defined by groove inclined walls 206a, 206b extending from a groove bottom 208. Together, inclined groove walls 206a, 206b and groove bottom 208 form a substantially ellipsoidal shape of the groove 200. An open end 202 of the groove 200 is open at the sidewall 148 and a closed end 204 of the groove 200 is not open to the sidewall 149.

Referring to FIGS. 8B and 6D, each groove 200 has a length (l₂), a width (w₂) and a depth (d₂). The depth (d₂) is a radial distance from the outer surface 142 to the groove bottom 208. The width (w₂) is a distance between the groove inclined walls 206a, 206b when viewed from the outer surface 142. The length (l₂) is a distance between the open and closed ends 202, 204 when viewed from the outer surface 142. All the grooves 200 of the second set of grooves have substantially the same length, depth and width configuration as each other. In other embodiments, at least some of the grooves 200 of the second set of grooves may have different size and shape configurations from each other. In some embodiments, the grooves 200 of the second set of grooves generally have a shape similar to a scaled down version of the shape of the grooves 180 of the first set of grooves.

The length (l₂), the width (w₂) and the depth (d₂) of each of the grooves 200 of the second set of grooves is smaller than the respective width (w₁), length (l₁), and depth (d₁) of the grooves 180 of the first set of grooves.

In this embodiment, the grooves 200 are disposed circumferentially between adjacent grooves 180 of the first plurality of grooves and in alternance therewith. Each groove 200 extends from the sidewall 148 to the lateral ridge 190.

A maximum length (l₂) of each groove 200 is less than about 50% of the tread width (t_{w}). In other words, the length (l₂) of each groove 200 does not extend beyond more than about 25% of the tread width (t_{w}).

As best seen in FIG. 7, the width (w₂) of each groove 200 decreases from the sidewall 148 towards the sidewall 149. Each groove 200 can be said to exhibit a progressive width profile. The maximum width is at the sidewall 148. The width of the groove 200 at the closed end 204 is less than a widest width (wl₁) of the lateral ridge. In some embodiments, the width (w₂) is between about 2 mm and about 20 mm, or between 2 mm and 15 mm, or between 2 mm and 10 mm.

As best seen in FIGS. 6C, 7 and 8B, each groove 200 exhibits a progressive depth profile in which the depth (d₂) decreases from the sidewall 148 towards the sidewall 149 of the groove 200. The depth (d₂) is greater proximate the sidewall 148 than at the sidewall 149. The depth (d₂) at the open end 202 is greater than the depth (d₂) at the closed end 204. The maximum depth (d₂) of the groove 200 ranges between 1.0 mm and 10 mm, more preferably between about 2 mm and about 5 mm. In certain embodiments, maximum depth (d₂) of grooves 200 is lower than the maximum depth (d₁) of the grooves 180.

As seen in FIG. 6D, a side-elevation profile of the groove 200 when viewed from the sidewall 148, is substantially U shaped. It will be appreciated that the profile of the groove 200 when viewed from the sidewall 148 becomes progressively smaller towards the sidewall 149. In alternative embodiments, the profile of the groove 200 when viewed from the sidewall 148, may be substantially V shaped.

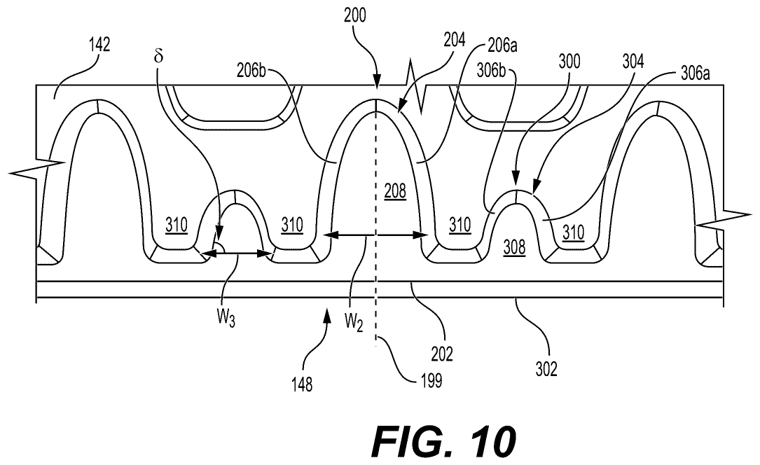

The cross-section of the resilient portion 140 of FIG. 8B shows that a slope of the groove bottom 208 has an elliptical profile. It is contemplated that the slope of the groove bottom 208 may have a profile that is substantially similar to the profiles of slopes of the groove inclined walls 206a, 206b (FIG. 10).

The grooves 200 comprise a transversal axis 199 that is parallel to an axis of rotation of the resilient portion 140.

Lateral ridges 210 separate adjacent grooves 200 of the second set of grooves. The lateral ridges 210 have a width that increases from the sidewall 148 towards the sidewall 149.

In addition to the second set of grooves 200 contributing, in collaboration with the first set of grooves 180, to the evacuation of snow, the second set of grooves 200 assist the resilient portion 140 in absorbing at least a portion of a shock due to an impact/obstacle and distributing the pressure evenly to the inner surface 74 of the endless track 70.

### Third Set of Grooves

Turning now to the third set of grooves 300 defined in the tread portion 170. The third set of grooves 300 comprises a plurality of grooves 300 formed in the resilient portion 140, each of the grooves 300 extending laterally from the sidewall 148 towards the sidewall 149 without extending completely across the entire tread width (tw). In other words, each groove 300 of the third set of grooves 300 stops short of the sidewall 149. The grooves 300 of the third set of grooves are spaced radially from one another, with a spacing between adjacent grooves 300 being a regular spacing. In other embodiments, the third plurality of grooves 300 may be irregularly spaced from one another.

As best seen in FIGS. 6B, 6D, 7 and 10, each groove 300 is defined by groove inclined walls 306a, 306b extending from a groove bottom 308. Together, inclined groove walls 306a, 306b and groove bottom 308 form a substantially ellipsoidal shape of the groove 300. An open end 302 of the groove 300 is open at the sidewall 148 and a closed end 304 of the groove 300 is not open to the sidewall 149.

Referring to FIGS. 8A and 6D, each groove 300 has a length (l₃), a width (w₃) and a depth (d₃). The depth (d₃) is a radial distance from the outer surface 142 to the groove bottom 308. The width (w₃) is a distance between the groove inclined walls 306a, 306b when viewed from the outer surface 142. The length (l₃) is a distance between the open and closed ends 302, 304 when viewed from the outer surface 142. All the grooves 300 of the third set of grooves have substantially the same length, depth and width configuration as each other. In other embodiments, at least some of the grooves 300 of the third set of grooves may have different size and shape configurations from each other.

The length (l₃), the width (w₃) and the depth (d₃) of each of the grooves 300 of the third set of grooves is smaller than the respective width (w₂), length (l₂), and depth (d₂) of the grooves 200 of the second set of grooves, as well as the respective width (w₁), length (l₁), and depth (d₁) of the grooves 180 of the first set of grooves.

In this embodiment, the grooves 300 are disposed circumferentially in alternance with the grooves 200 so that each groove 300 is in lateral alignment with a respective groove 180, and each groove 300 is separated from the respective groove 180 by a lateral ridge 310.

A maximum length (l₃) of each groove 300 is about 30% of the tread width (t_{w}). In other words, the length (l₃) of each groove 300 does not extend beyond more than about 25% of the tread width (t_{w}).

As best seen in FIG. 7, the width (w₃) of each groove 300 decreases from the sidewall 148 towards the sidewall 149. Each groove 300 can be said to exhibit a progressive width profile.

As best seen in FIGS. 6C, 7 and 8B, each groove 300 exhibits a progressive depth profile in which the depth (d₃) decreases from the sidewall 148 towards the sidewall 149 of the groove 300. The depth (d₃) is greater proximate the sidewall 148 than at the sidewall 149. The depth (d₃) at the open end 302 is greater than the depth (d₃) at the closed end 304. The maximum depth (d₃) of the groove 300 ranges between about 1 mm and about 25 mm, more preferably between about 1 mm and about 10 mm. The maximum depth (d₃) of grooves 300 is lower than the maximum depth (d₁) of the grooves 180. The grooves 300 have a maximum depth d₃ lower than or equal to the maximum depth d₂ of the grooves 200. In some instances, it is desirable for the ratio of the depth of the of first grooves 180 to that of the third grooves 300 to range from 2 to 25. In some instances, it is desirable for the ratio of the depth of the of second grooves 200 to that of the third grooves 300 to range from 2 to 25.

As seen in FIG. 6D, a side-elevation profile of the groove 300 when viewed from the sidewall 148, is substantially U shaped. It will be appreciated that the profile of the groove 300 when viewed from the sidewall 148 becomes progressively smaller towards the sidewall 149. In alternative embodiments, the profile of the groove 300 when viewed from the sidewall 148, may be substantially V shaped.

The cross-section of the resilient portion 140 of FIG. 8A shows that a slope of the groove bottom 308 has an elliptical profile. It is contemplated that the slope of the groove bottom 208 may have a profile that is substantially similar to the profiles of slops of the groove inclined walls 386a, 386b. As best seen in FIG. 7, the groove inclined walls 306a, 306b of each groove 300 form an angle δ with the groove bottom 308. The angle δ ranges between about 25° and about 90°.

The grooves 300 comprise a transversal axis that is parallel to an axis of rotation of the resilient portion 140.

Lateral ridges 310 separate adjacent grooves 300 of the third set of grooves 300. The lateral ridges 310 have a width that increases from the sidewall 148 towards the sidewall 149.

It is believed that the ellipsoid configuration of the groove 300 performs a blade-like effect that funnels the debris (e.g., snow and sand) out of the resilient portion 140.

In certain embodiments, the third set of grooves 300 are omitted from the tread portion 170.

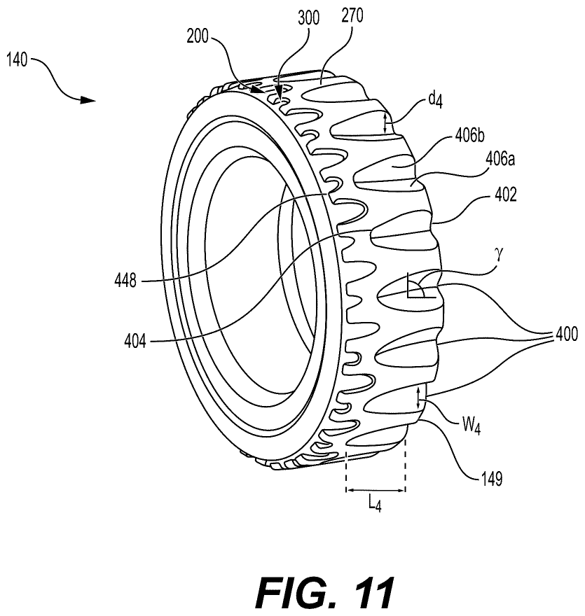

FIG. 11 shows a further embodiment of a tread portion 270 according to the present technology. The tread portion 270 comprises a first set of grooves 400 formed in the resilient portion 140, each of the grooves 400 extending laterally from the sidewall 149 towards the sidewall 148 without extending completely across the entire tread width (tw). In other words, each groove 400 of the first set of grooves 400 stops short of the sidewall 148. The grooves 400 of the first set of grooves are spaced radially from one another, with a spacing between adjacent grooves 400 being regular. In other embodiments, the first set of grooves 400 may be irregularly spaced from one another.

Each groove 400 is defined by groove inclined walls 406a, 406b which intersect at a base of the groove 400 in a V configuration. The groove inclined walls 406a, 406b of grooves 400 preferably form an angle g with each other that is of about 80°. In some embodiments, the angle g may be between about 60° and about 110°. An open end 402 of the groove 400 is open at the sidewall 149 and a closed end 404 of the groove 400 is not open to the sidewall 148.

Each groove 400 has a length (l₄), a width (w₄) and a depth (d₄). The depth is a radial distance from the outer surface 142 to the base of the groove 400. The width (w₄) is a distance between the groove inclined walls 406a, 406b when viewed from the outer surface 142. The length (l₄) is a distance between the open and closed ends 402, 404 when viewed from the outer surface 142. All the grooves 400 of the plurality of grooves have substantially the same length, depth and width configuration as each other. In other embodiments, at least some of the grooves 400 of the first set of grooves may have different size and shape configurations from each other.

A maximum length (l₄) of each groove 400 is between about 50% to about 85%; or between 60% and 80%, or between about 66% and about 75% of the tread width (t_{w}).

The width (w₄) of each groove 400 decreases from the sidewall 149 towards the sidewall 148. Each groove 400 can be said to exhibit a progressive width profile. The maximum width is at the sidewall 149. In some embodiments, the width (w₄) is between about 5 mm and about 20 mm, or between 5 mm and 15 mm, or between 5 mm and 10 mm.

Each groove 400 exhibits a progressive depth profile in which the depth (d₄) decreases from the sidewall 149 towards the sidewall 148 of the groove 400. The depth is greater proximate the sidewall 149 than at the sidewall 148. The depth (d₄) at the open end 402 is greater than the depth (d₄) at the closed end 404. The maximum depth (d₄) of the groove 400 ranges between 5.0 mm and 10.0 mm, more preferably between 6.0 mm and 9.0 mm. In certain embodiments, each groove 400 has a maximum depth (d₄) of 7.5 mm.

A side-elevation profile of the groove 400 when viewed from the sidewall 149, is substantially V shaped. It will be appreciated that the profile of the groove 400 when viewed from the sidewall 149 becomes progressively smaller towards the sidewall 148.

The grooves 400 have a maximum depth (d₄) that is bigger than the maximum depth d₂ of the grooves 200 and bigger than the maximum depth (d₃) of the grooves 300 (if present).

The tread portion 270 of FIG. 11 further includes the second set of grooves 200 and the third set of grooves 300 as previously described.

In some instances, the presence of the third set of grooves 300 assists the first and the second sets of grooves 400, 200 to evacuate the snow. The third set of grooves 300 assist the resilient portion 140 in absorbing and distributing the force of an impact/obstacle.

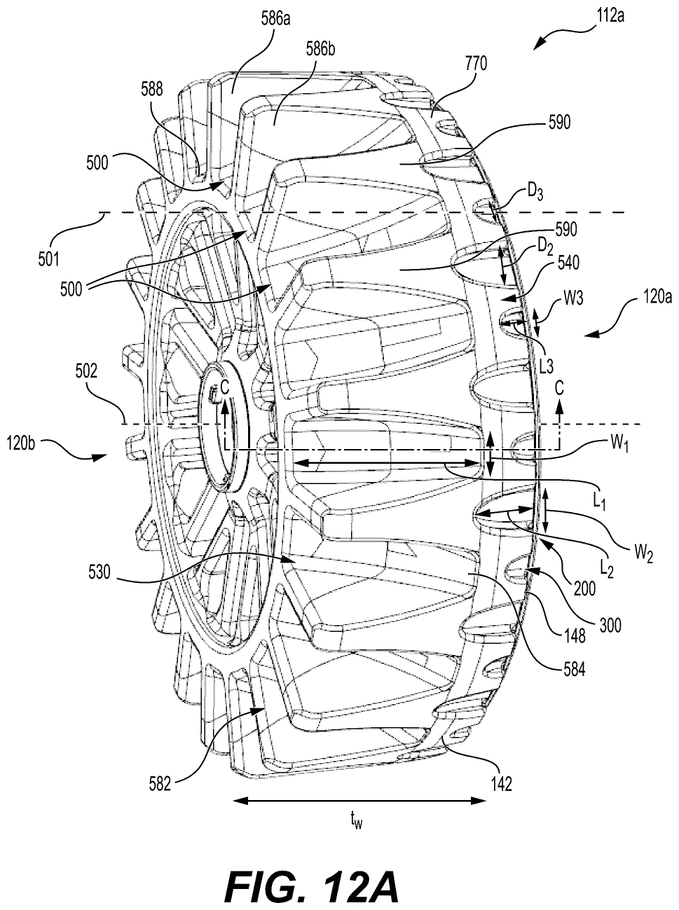

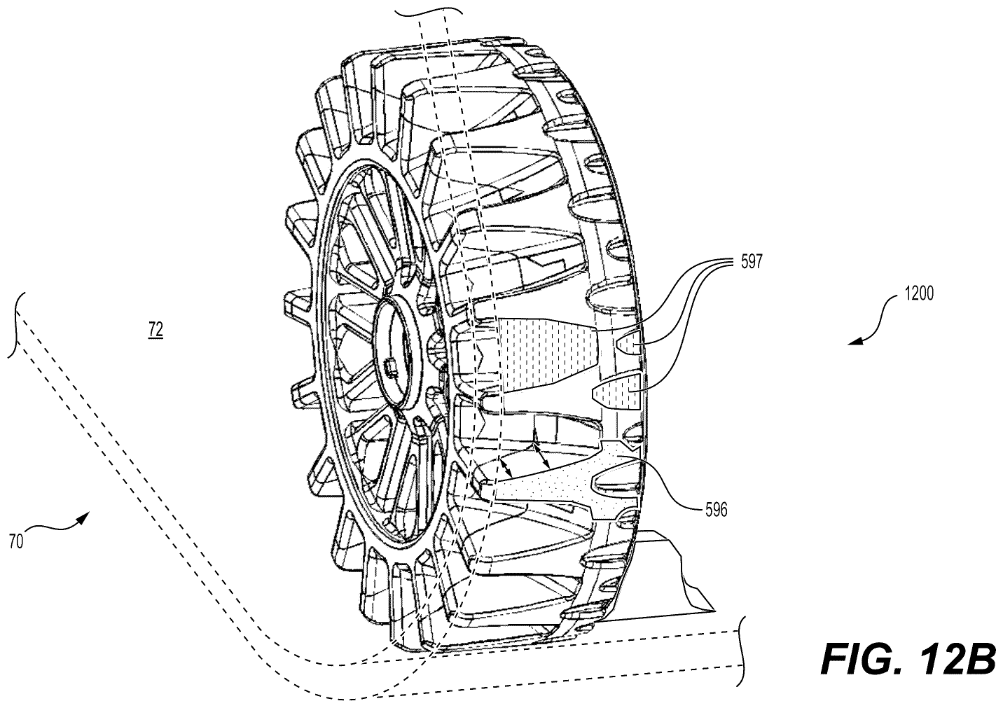

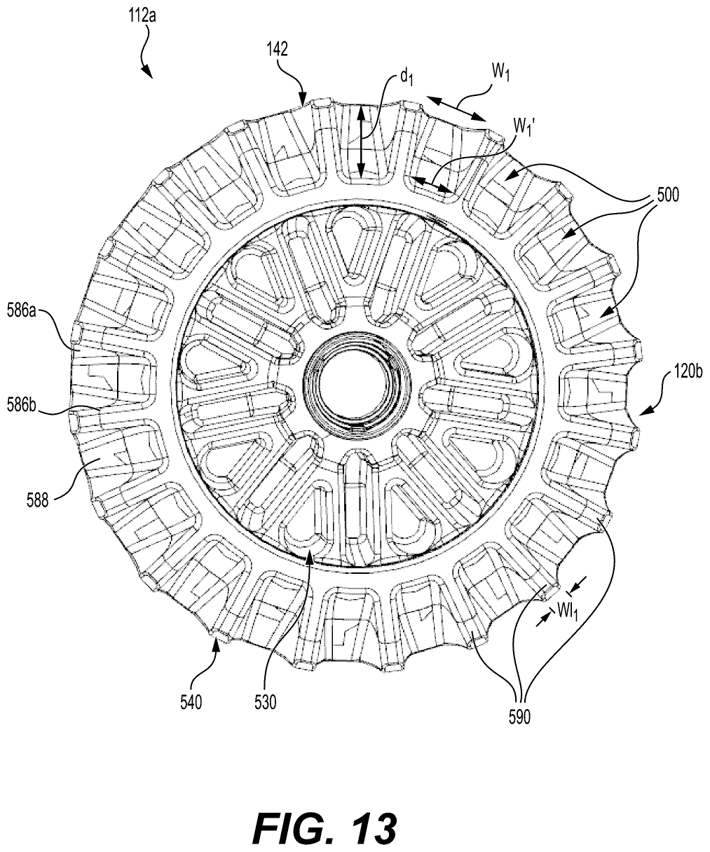

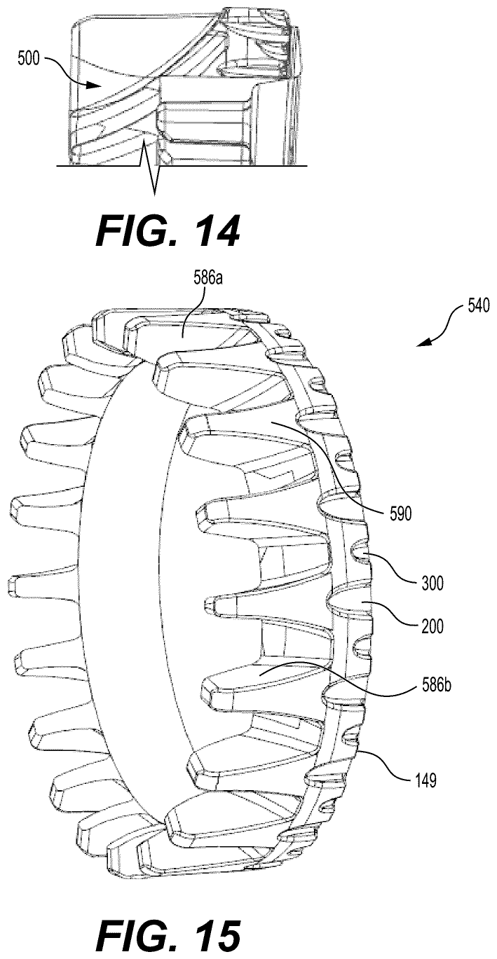

FIGS. 12A, 12B, 13, 14, 15 and 16 show a further embodiment of the wheel 112a. The wheel 112a of FIG. 12A comprises an inner side 120a and an outer side 120b, a hub portion 530 and a resilient portion 540. Unlike the embodiments of FIGS. 5-11, in the embodiments of FIGS. 12-16 a first set of grooves 500 is formed in both a tread portion 770 of the resilient portion 540 and the hub portion 530. In other words, each groove 500 is defined in part in both the resilient portion 540 and the hub portion 530. The groove 500 is open at the outer side 120b of the wheel 112a. Reference to the groove 500 refers to the entire groove extending across the hub and resilient portions 530, 540.

Each groove 500 extends laterally from the outer side 120b towards the inner side 120a, without extending completely across the entire tread width (t_{w}). In other words, each groove 500 of the first set of grooves 500 stops short of the sidewall 148. The grooves 500 of the first set of grooves are spaced radially from one another, with a spacing between adjacent grooves 500 being regular. In other embodiments, the first set of grooves 500 may be irregularly spaced from one another.

As best seen in FIG. 12A, each groove 500 is defined by groove inclined walls 586a, 586b extending from a groove bottom 588. The groove inclined walls 586a, 586b and the groove bottom 588 extend across both the hub and resilient portions 530, 540. Together, the groove inclined walls 586a, 586b and groove bottom 588 form a substantially frustoconical shape of the groove 500. An open end 582 of the groove 500 is open at the outer side 120b of the wheel 112a and a closed end 584 of the groove 500 is not open to the sidewall 148.

Each groove 500 has a length (l1), a width (w1) and a depth (d1). The depth is a radial distance from the outer surface 142 to the groove bottom 588. The width (w1) is a distance between the groove inclined walls 586a, 586b when viewed from the outer surface 142. The length (l1) is a distance between the open and closed ends 582, 584 when viewed from the outer surface 142. All the grooves 500 of the first set of grooves have substantially the same length, depth and width configuration as each other. In other embodiments, at least some of the grooves 500 of the first set of grooves may have different size and shape configurations from each other.

In some embodiments, a maximum length (l1) of each groove 500 is between about 50% to about 85%; or between 60% and 80%, or between about 66% and about 75% of the tread width (tw). In some embodiments, the length 11 is 60.3 mm, or is between 60.0 mm and 65.0 mm. Other configurations are contemplated as well.

The width (w1) of each groove 500 decreases from the outer side 120b towards the inner side 120a of the wheel 112a. Each groove 500 can be said to exhibit a progressive width profile. The maximum width is at the outer side 120b. In some embodiments, the width (w1) is between 20.0 mm and about 40.0 mm, or between 23.0 mm and 35.0 mm, or between 23.4 mm and 34.5 mm. In one embodiment, the maximum width (w1) is 34.5 mm and the minimum width (w1′) is 23.4 mm. Other configurations are contemplated as well.

Each groove 500 also exhibits a progressive depth profile in which the depth (d₁) decreases from the outer side 120b towards the inner side 120a. The depth is greater proximate the outer side 120b than at the inner side 120a. The depth (d₁) at the open end 582 is greater than the depth (d₁) at the closed end 584. The maximum depth (d₁) of the groove 500 ranges between about 30 mm and about 50 mm, more preferably between about 35 mm and about 45 mm. In certain embodiments, each groove 500 has a maximum depth (d₁) of about 42 mm. In some instances, the slope of each groove 500 facilitates removal of the snow. Other configurations are contemplated as well.

Each groove 200 has a length (l2), a width (w2) and a depth (d2). All the grooves 200 of the second set of grooves have substantially the same length, depth and width configuration as each other. In other embodiments, at least some of the grooves 200 of the second set of grooves may have different size and shape configurations from each other. In some embodiments, the length (l2) is 25.4 mm, or is between 20.0 mm and 30.0 mm. Other configurations are contemplated as well. Each groove 200 can be said to exhibit a progressive width profile. In some embodiments, the width (w2) is between about 10 mm and about 20 mm, or between about 12 mm and about 16 mm. In one embodiment, the maximum width (w2) is 15.1 mm. In one embodiment, the depth (d2) is 5.08 mm. Other configurations are contemplated as well.

Each groove 300 has a length (l3), a width (w3) and a depth (d3). All the grooves 300 of the third set of grooves have substantially the same length, depth and width configuration as each other. In other embodiments, at least some of the grooves 300 of the third set of grooves may have different size and shape configurations from each other. In some embodiments, the length (l3) is about 10.7 mm, or is between 8.0 mm and 15.0 mm. Other configurations are contemplated as well. Each groove 300 can be said to exhibit a progressive width profile. In some embodiments, the width (w3) is between about 5 mm and about 10 mm, or between about 8 mm and about 9 mm. In one embodiment, the maximum width (w3) is 8.5 mm. In one embodiment, the depth (d3) is 5.08 mm. Other configurations are contemplated as well.

A profile of the groove 500 when viewed from the outer side 120b, is substantially U shaped. It will be appreciated that the profile of the groove 500 when viewed from the outer side 120b becomes progressively smaller towards the sidewall 148.

Lateral ridges 590 separate adjacent grooves 500 of the first set of grooves. The lateral ridges 590 have a width (wl₁) that increases from the outer side 120b towards the inner side 120a. A longitudinal axis of the lateral ridges 590 (when viewed from the outer surface 142) is linear. In one embodiment, the width (wl1) is 11.43 mm.

The grooves 500 comprise a transversal axis 501 that is parallel to an axis of rotation 502 of the resilient portion 540.

The grooves 500 of the first set of grooves allow snow to be funneled towards the open end 584 of the groove at the outer side 120b of the wheel 112a and contribute to evacuating the snow out of the groove 500. The groove 500 configuration may also prevent the snow from accumulating (building-up) on the tread portion 570. Ultimately, it is understood that the snow is then thus evacuated from the track system.

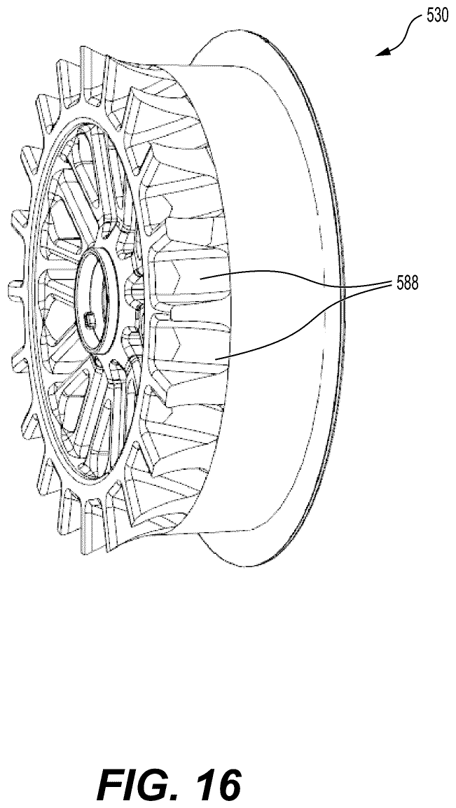

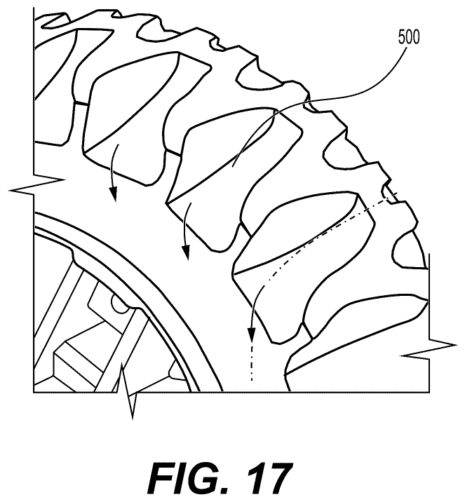

The hub and resilient portions 530, 540 connect together to form the grooves 500. The resilient portion 540, isolated from the hub portion 530, is shown in FIG. 15, and hub portion 530, isolated from the resilient portion 540, is shown in FIG. 16. As can be seen, the groove bottom 588 is defined by the hub portion 530, and the groove inclined walls 586a, 586b are defined by both the hub and resilient portions 530, 540. In other embodiments, the hub and resilient portions 530, 540 may define the groove 500 in any other manner. The hub and resilient portions 530, 540 may have a non-rectilinear join which may favour mechanical interlocking between the two. In such embodiments, a stiffness of the tread portion can be greater or otherwise modified by minimizing buckling of the lateral ridges 590.

As shown in the FIG. 12B, the tread portion has a tread pattern 1200 defining pressure zones 596 and 597. During operation, the pressure zones 596 of the tread pattern 1200 apply a relatively high pressure on the endless track 70, if compared to the pressure zones 597 for example, which forces debris (e.g., snow) to be displaced toward the pressure zones 597. When the debris is introduced into the pressure zones 597, the debris is evacuated due to the shape of the corresponding grooves forming the pressure zones 597.

During operation, the pressure zones 597 of the tread pattern 1200 apply relatively low pressure on the endless track 70, if compared to the pressure zones 596, for example. It should be noted that the depth of the corresponding groove in the pressure zone 597 varies along the width of the corresponding groove. In one example, the given groove 500 has a first depth 599 along the length of the groove 500, and a second depth 598 along the length of the given groove 500. Developers of the present technology have realized that this variation in depth of a given groove provides different rigidities of the resilient material along the length of the tread pattern 1200 and therefore allows to vary the pressure applied onto the endless track along the length of tread pattern 1200. This pressure dampening effect may be used to cushion a portion of impacts/bumps during operation.

In yet other embodiments (FIG. 17), the longitudinal axis of the lateral ridges 590 (when viewed from the outer surface 142) is not straight but flares outwardly at the outer side 120b. This axial curvature can modulate how the snow projects out of the grooves 500. For instance, the longitudinal axis of the lateral ridges can be not straight (e.g., bent, curved, skewed) and directed towards the rear end of the track system so that the snow is projected outwardly and rearwardly (shown as arrows on FIG. 17). The inclination/curve of the longitudinal axis of the lateral ridges is generally progressive to avoid creating restriction/constraint that could be detrimental to evacuation of snow from the grooves 500. Having a non-linear longitudinal axis, a longitudinal offset is formed between the open end 582 and the closed end 584. In some cases, this can contribute to avoid snow being pushed out from a wheel and being re-ingested by a subsequent one. In other words, directing the projection of snow can improve snow ingestion and evacuation by the groove 500.

The tread portion 570 further includes the second set of grooves 200 and the third set of grooves 300 as previously described. The profile of the grooves (e.g., 180, 200, 300, 400 and 500) follows a curve that is similar to that of an ellipse with 2 radii of curvature. The flexible walls of the grooves force the snow into the grooves. The grooves open outwardly so as to prevent snow from accumulating therein and forming a “bottleneck”. The progressive radius of grooves allows for smoother snow movement.

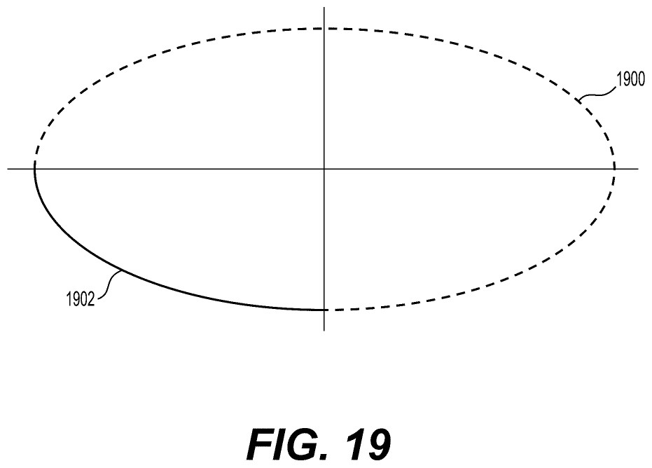

With reference to FIG. 19, there is depicted an ellipse 1900. Broadly speaking, an ellipse is a 2D curve that is a locus of all points in a plane that have the same sum of distances to two fixed points, called foci.

The ellipse 1900 has an elliptical profile 1902. It should be noted that the bending radius along the elliptical profile progressively changes. It can also be said that the elliptical profile 1902 has a plurality of different bending radii at respective stations along the elliptical profile 1902. It can also be said that the elliptical profile 1902 has a plurality of different normal directions at respective stations along the elliptical profile 1902.

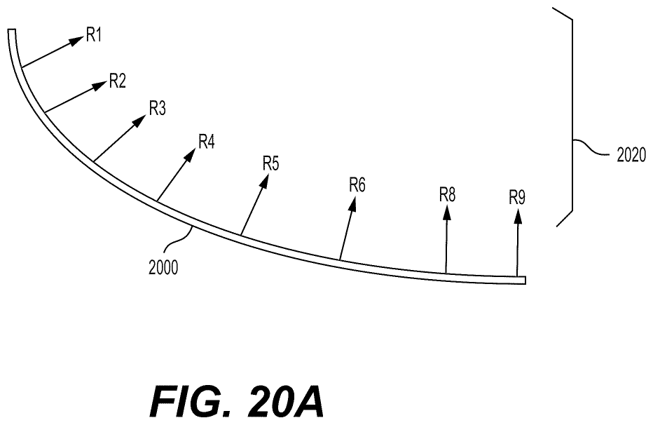

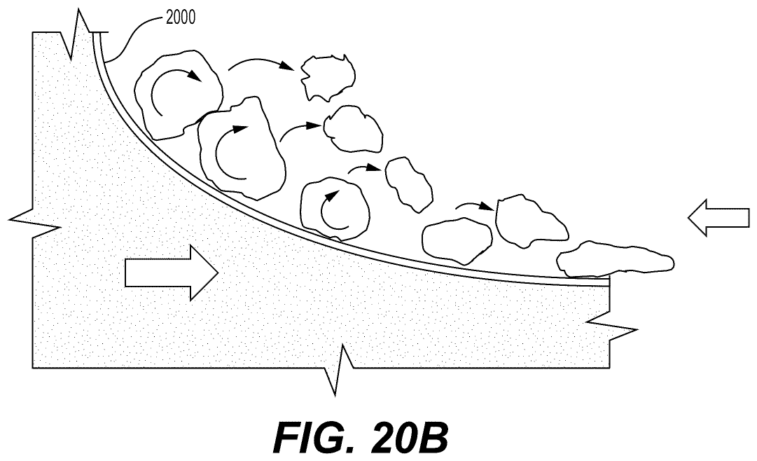

With reference to FIG. 20A, there is depicted a 2D representation of an ellipsoidal shape having an elliptical profile 2000. As seen, the elliptical profile has a plurality of bending radii 2020 comprising bending radii R1 to R9 at respective stations of the elliptical profile 2000, and which are different from one another. It can be said that the plurality of being radii 2020 comprises a plurality of mutually different bending radii.

With reference to FIG. 20B, there is depicted a simplified representation of a slope of a groove surface having the elliptical profile 2000. In this example, it can be said that the grooved surface is a surface a groove having an ellipsoidal shape. Developers have realized that providing grooves with an ellipsoid shape—that is, a groove having one or more sloped groove surfaces/walls with elliptical profiles—are better suited for managing accumulation of debris (especially snow) inside the groove. Developers have realized that having a plurality of different bending radii promotes movement of debris due to progressive changes in surface orientation and which causes the debris to break-up and/or roll out of the groove, instead of undergoing compression, for example.

It is contemplated that any groove from the first plurality of grooves, the second plurality of grooves, and/or the third plurality of grooves may have an ellipsoidal shape and/or one ore more slopes groove surfaces with an elliptical profile, without departing from the scope of the present technology.

Without being bound by theory, the grooves form flexible ridges that deform and prevent snow from compacting and sticking (e.g., build-up). Additionally, the groove profiles are designed to facilitate outward movement of snow. In some instances, the grooves act as stiffness modifiers of the resilient portion. The grooves allow to shovel snow out of the surface of the resilient portion and also act as cutouts that weaken the resilient portion by forming flexible ridges.

1. A wheel for a track system, comprising:
a hub portion and a tread portion disposed about the hub portion, the tread portion comprising:
a first plurality of grooves extending laterally from a first sidewall of the tread portion towards a second sidewall of the tread portion, the first plurality of grooves being circumferentially spaced along the tread portion,
a radial depth of a first groove from the first plurality of grooves being greater proximate to the first sidewall than proximate to the second sidewall,
the first groove having an ellipsoidal shape.

2. The wheel of claim 1, wherein the first groove has a groove surface, a slope of the groove surface having an elliptical profile.

3. The wheel of claim 2, wherein the groove surface is at least one of a bottom surface and a sidewall of the first groove.

4. The wheel of claim 1, wherein the first groove has a transversal axis that is parallel to an axis of rotation of the wheel.

5. The wheel of claim 1, wherein the first groove has an axial curvature for expelling debris from the first groove.

6. The wheel of claim 1, wherein the first groove comprises a flexible ridge for expelling debris out of the first groove.

7. The wheel of claim 1, wherein the first plurality of grooves is formed from joining the hub portion and the tread portion together.

8. The wheel of claim 1, wherein the tread portion further comprises:
a second plurality of grooves extending laterally from the second sidewall towards the first sidewall, the second plurality of grooves being circumferentially spaced along the tread portion,
a radial depth of a second groove from the second plurality of grooves being greater proximate to the second sidewall than proximate the first sidewall,
the second groove having a length smaller than a length of the first groove.

9. The wheel of claim 8, wherein the second groove is disposed circumferentially between two adjacent grooves of the first plurality of grooves.

10. The wheel of claim 8, wherein the second groove has an ellipsoidal shape.

11. The wheel of claim 1, wherein the wheel is an idler wheel of the track system.

12. The wheel of claim 1, wherein the wheel is a support wheel of the track system.

13. The wheel of claim 1, wherein the wheel is an idler-support wheel of the track system.

14. The wheel of claim 1, wherein the tread portion is made of resilient material.

15. The wheel of claim 14, wherein the resilient material is an elastomer.

16. The wheel of claim 1, wherein the wheel further comprises:
a third plurality of grooves extending laterally from the second sidewall towards the first sidewall, the third plurality of grooves being circumferentially spaced along the tread portion,
a radial depth of a third groove from the third plurality of grooves being greater proximate to the second sidewall than proximate to the first sidewall,
the third groove being laterally aligned with a corresponding groove of the first plurality of grooves.

17. The wheel of claim 16, wherein the third groove has an ellipsoidal shape.

18. A track system for a vehicle, the track system comprising:
a frame,
a drive wheel assembly rotationally connected to the frame and operatively connectable to the vehicle;
a wheel assembly rotationally connected to the frame; and
an endless track surrounding the drive wheel assembly and the wheel assembly, the endless track being drivingly engaged with the drive wheel assembly,
wherein the wheel assembly comprises a wheel, the wheel comprises a hub and a tread portion disposed about the hub, the tread portion comprising:
a first plurality of grooves extending laterally from a first sidewall of the tread portion towards a second sidewall of the tread portion, the first plurality of grooves being circumferentially spaced along the tread portion,
a radial depth of a first groove from the first plurality of grooves being greater proximate to the first sidewall than proximate to the second sidewall,
the first groove having an ellipsoidal shape.

19. The track system of claim 18, wherein the wheel assembly is an idler wheel assembly.

20. The track system of claim 18, wherein the wheel assembly is a support wheel assembly.
